(19) United States
(12) Patent Application Publication
(10) Pub. No.: US 2021/0097696 A1
(43) Pub. Date: Apr. 1, 2021

(54) MOTION ESTIMATION METHODS AND MOBILE DEVICES

(71) Applicant: SZ DJI TECHNOLOGY CO., LTD., Shenzhen (CN)

(72) Inventors: Changchun YE, Shenzhen (CN); You ZHOU, Shenzhen (CN); Jiaqi YAN, Shenzhen (CN)

(73) Assignee: SZ DJI TECHNOLOGY CO., LTD., Shenzhen (CN)

(21) Appl. No.: 17/120,452

(22) Filed: Dec. 14, 2020

Related U.S. Application Data
(63) Continuation of application No. PCT/CN2018/096681, filed on Jul. 23, 2018.

(51) Int. Cl. G06T 7/207; G06T 7/246; G06T 7/13; G06T 7/529; G06T 7/579

(52) U.S. Cl. CPC G06T 7/207; G06T 7/246; G06T 7/13; G06T 2207/10028; G06T 7/579; G06T 2207/10016; G06T 7/529

(57) ABSTRACT

A motion estimation method and a mobile device are provided. The method includes: detecting whether a scene in which a mobile device is currently located is a dark scene or a textureless scene; when the scene is a dark scene or a textureless scene, obtaining a first depth map of the scene by using a distance measurement module in the mobile device; determining a vertical distance between the mobile device and the ground at a current moment based on the first depth map; and determining a moving speed of the mobile device from a previous moment to the current moment along a vertical direction based on a vertical distance between the mobile device and the ground at the previous moment and the vertical distance between the mobile device and the ground at the current moment. Therefore, accuracy of motion estimation in a dark or textureless scene can be improved.

### RELATED APPLICATIONS

This application is a continuation application of PCT application No. PCT/CN2018/096681, filed on Jul. 23, 2018, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the automation field, and specifically, to a motion estimation method and a mobile device.

### BACKGROUND

With development of computer vision technologies, computer vision systems are applied more extensively.

A computer vision system (hereinafter referred to as a vision system for short) may be used to calculate a position-posture change of a mobile device from a previous moment to a current moment, so as to perform motion estimation on the mobile device (or tracking the mobile device).

However, a motion estimation mode based on the vision system depends on texture information of a shot image. If a scene in which the mobile device is currently located is dark or textureless, the vision system can hardly make accurate motion estimation on the mobile device.

### SUMMARY

The present disclosure provides a motion estimation method and a mobile device, which can improve the accuracy of motion estimation of a mobile device in a dark or textureless scene.

In a first aspect, the present disclosure provides a motion estimation method for a mobile device, including: detecting whether a scene in which the mobile device is currently located is a dark scene or a textureless scene; after detecting that the scene is a dark scene or a textureless scene, obtaining a first depth map of the scene with a distance measurement module in the mobile device; determining a vertical distance between the mobile device and ground at a current moment based on the first depth map; and determining a moving speed of the mobile device from a previous moment to the current moment in a vertical direction based on a vertical distance between the mobile device and the ground at the previous moment and the vertical distance between the mobile device and ground at the current moment.

In a second aspect, the present disclosure provides a mobile device, including: a distance measurement module; at least one memory storing a set of instructions; and at least one processor in communication with the at least one memory, wherein during operation, the at least one processor executes the set of instructions to: detect whether a scene in which the mobile device is currently located is a dark scene or a textureless scene; after detecting that the scene is a dark scene or a textureless scene, obtain a first depth map of the scene with the distance measurement module; determine a vertical distance between the mobile device and ground at a current moment based on the first depth map; and determine a moving speed of the mobile device from a previous moment to the current moment in a vertical direction based on a vertical distance between the mobile device and the ground at the previous moment and the vertical distance between the mobile device and ground at the current moment.

When the mobile device is located in a dark or textureless scene, the distance measurement module may be used to perform motion estimation on motion of the mobile device in the vertical direction. The use of the distance measurement module is independent from the brightness and texture of an environment. Therefore, the accuracy of motion estimation on the mobile device in a dark or textureless scene can be improved.

### BRIEF DESCRIPTION OF THE DRAWINGS

FIG. 1 is a schematic flowchart of a motion estimation method for a mobile device according to some exemplary embodiments of the present disclosure;

FIG. 2 is a schematic flowchart of a detection mode in a dark scene according to some exemplary embodiments of the present disclosure;

FIG. 3 is a schematic flowchart of a detection mode in a textureless scene according to some exemplary embodiments of the present disclosure;

FIG. 4 is a schematic flowchart of a possible implementation of step S130 in FIG. 1;

FIG. 5 is a schematic flowchart of a possible implementation of step S430 in FIG. 4;

FIG. 6 is a schematic flowchart of a possible implementation of step S520 in FIG. 5; and

FIG. 7 is a schematic structural diagram of a mobile device according to some exemplary embodiments of the present disclosure.

### DETAILED DESCRIPTION

A mobile device mentioned in exemplary embodiments of the present disclosure may be, for example, a handheld photographing device (such as a selfie stick or a gimbal), an aerial photographing aircraft, an unmanned vehicle, an unmanned aerial vehicle, virtual reality (VR) glasses, augmented reality (AR) glasses, or a mobile phone (such as a mobile phone having dual cameras), or may be any other type of vehicle having a camera (for example, multiple cameras).

Vision systems are applied increasingly extensively on mobile devices. Taking a vision system applied on an unmanned aerial vehicle as an example, the following describes an application mode of the vision system. To improve motion estimation or positioning capabilities of unmanned aerial vehicles, some unmanned aerial vehicle manufacturers provide the unmanned aerial vehicles with a positioning system combining a vision system and an inertial navigation system (visual-inertial navigation positioning system) in. A simple visual-inertial navigation positioning system may include a camera and an inertial measurement unit (IMU). The camera may be responsible for capturing image information of a scene in which the unmanned aerial vehicle is located. The IMU may be responsible for capturing information such as a tri-axis posture angle (or angular speed) and/or acceleration of the unmanned aerial vehicle. By means of the visual-inertial navigation positioning system and a visual positioning algorithm, the unmanned aerial vehicle can have accurate motion estimation and positioning in an area where a global positioning system (global positioning system, GPS) signal is weak or even there is no GPS signal, so that stable hovering and path planning of the unmanned aerial vehicle are implemented. The visual positioning algorithm may be, for example, a visual odometry (VO) algorithm or a visual inertial odometry (VIO) algorithm.

The motion estimation or positioning mode based on the vision system depends on texture information in a captured image. However, in some scenes, rich texture information cannot be obtained, resulting in inaccuracy of motion estimation or positioning, or even resulting in failure of motion estimation or positioning. A scene in which rich texture information cannot be obtained may be, for example, a dark scene (for example, a night scene), or may be a textureless scene (such as a pure-color scene).

Therefore, some exemplary embodiments of the present disclosure provide a motion estimation method for a mobile device, to accurately estimate motion of the mobile device in a vertical direction (or a gravity direction) in a dark scene or a textureless scene.

FIG. 1 is a schematic flowchart of a motion estimation method for a mobile device according to some exemplary embodiments of the present disclosure. The mobile device has a distance measurement module. The distance measurement module may also be referred to as a distance sensor (or referred to as a distance measurement sensor or a sensor for measuring a depth of field). The distance measurement module may be a time of flight (ToF)-based distance measurement module (such as a 3D-ToF sensor), or may be a phase-based distance measurement module. The distance measurement module may be a laser distance measurement module, or may be an infrared distance measurement module. As an example, the distance measurement module may be a three-dimensional depth sensor based on structured light (such as infrared structured light).

The method in FIG. 1 may include step S110 to step S140. The following describes each step in FIG. 1 in detail.

Step S110: Detect whether a scene in which a mobile device is currently located is a dark scene or a textureless scene.

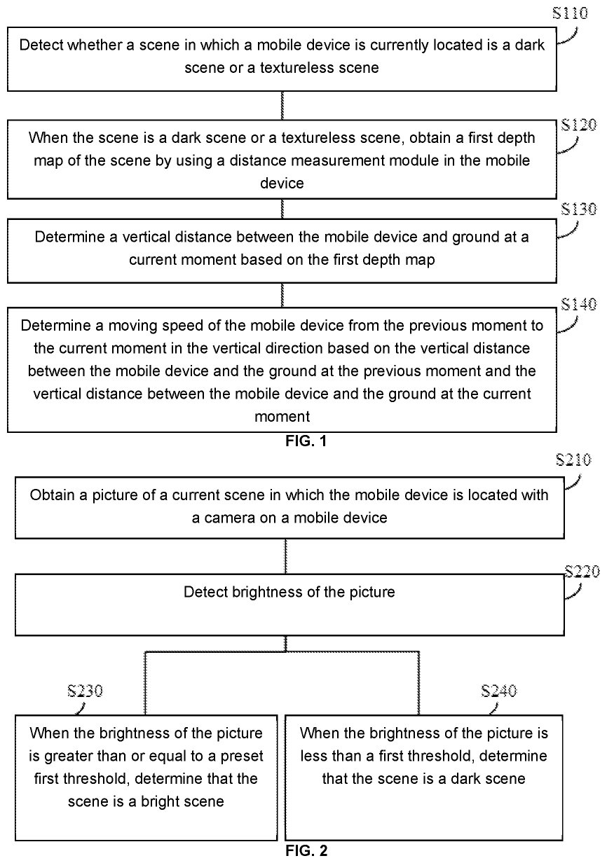

The dark scene may be, for example, a night scene, or an indoor scene with weak light or without light. There may be a plurality of ways to detect whether the current scene is a dark scene. For example, a user may determine the type of scene and send a determining result to the mobile device; and then the mobile device may determine, based on the determining result provided by the user, whether the current scene is a dark scene. For another example, the mobile device may automatically detect whether the current scene is a dark scene. For example, the mobile device may photograph the current scene through a camera (which may be, for example, a grayscale camera), and determine, based on brightness of a shot picture, whether the scene is a dark scene. For another example, a light sensor may be installed on the mobile device, and the mobile device may use the light sensor to determine whether the current scene is a dark scene. With reference to FIG. 2, a detailed example of a detection mode in a dark scene will be provided later.

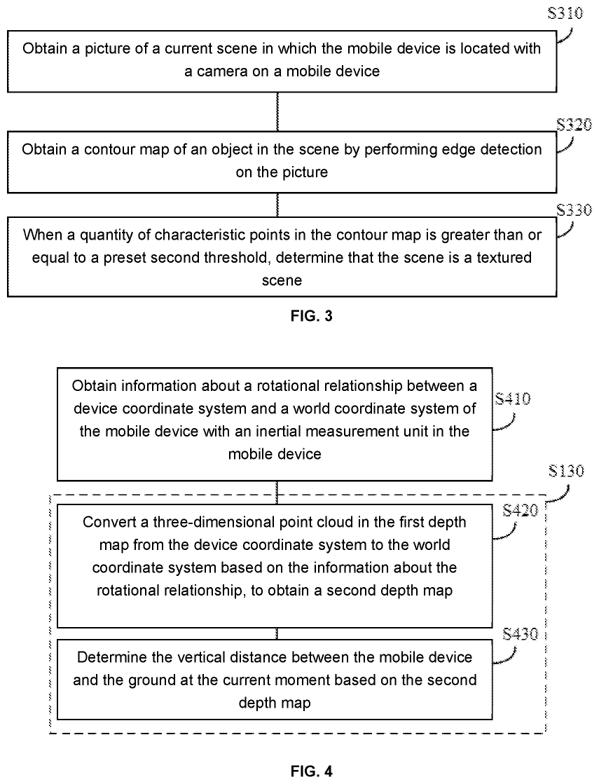

A textureless scene is a scene (or a picture corresponding to a scene) that includes limited texture information or even has no texture information. The textureless scene may be, for example, a pure-color scene (such as a photo studio with a pure-color background). Whether the current scene is a textureless scene may be determined by the user (and the user sends a determining result to the mobile device), or may be automatically detected by the mobile device. This is not limited in the present disclosure. With reference to FIG. 3, a detailed example of a detection mode in a textureless scene will be provided later.

Step S120: When the scene is a dark scene or a textureless scene, obtain a first depth map of the scene by using a distance measurement module in the mobile device.

The first depth map may include a three-dimensional point cloud of the current scene. The first depth map may be an original depth map obtained based on measurement information of the distance measurement module, or may be a depth map obtained after an original depth map is preprocessed. The preprocessing may include, for example, an operation such as speckle filtering. In this way, the transition of the three-dimensional point cloud in the depth map becomes smoother, and the noise in the depth map is suppressed.

Step S130: Determine a vertical distance between the mobile device and ground at a current moment based on the first depth map.

The current moment mentioned in this exemplary embodiment of the present disclosure may be a current image capture moment. Likewise, a previous moment may be a previous image capture moment. A time interval may be preset based on an actual situation, for example, determined based on the precision of motion estimation, or a frequency of image sampling. As an example, a time interval between the previous moment and the current moment may be set to 50 ms.

There may be a plurality of ways to implement step S130. For example, the first depth map may be used to determine a location of ground in the current scene, and then the vertical distance between the mobile device and ground at the current moment is determined based on the location of ground in the current scene. For another example, a registration relationship between the first depth map and a depth map obtained at the previous moment may be used to determine a motion distance of the mobile device in a vertical direction from the previous moment to the current moment, and the vertical distance between the mobile device and ground is then determined based on a vertical distance between the mobile device and ground at the previous moment and the motion distance of the mobile device in the vertical direction from the previous moment to the current moment. The implementations of step S130 will be described later with reference to a specific exemplary embodiment. Step S140: Determine a moving speed of the mobile device from the previous moment to the current moment in the vertical direction based on the vertical distance between the mobile device and the ground at the previous moment and the vertical distance between the mobile device and the ground at the current moment.

Assuming that a sampling frequency of the distance measurement module is 20 Hz, an interval T between the previous moment and the current moment is 50 ms. A moving speed vᵢ of the mobile device in the vertical direction from the previous moment to the current moment may be obtained by calculation through the following formulas:

Δhᵢ=hᵢ−hᵢ₋₁; and

vᵢ=Δhᵢ/T;

where hᵢ represents the vertical distance between the mobile device and the ground at the current moment, and hᵢ₋₁ represents the vertical distance between the mobile device and ground at the previous moment.

It should be noted that in some applications, if an application requirement can be satisfied only by obtaining the vertical distance between the mobile device and ground, only step S130 may be performed, and step S140 does not need to be performed.

In this exemplary embodiment of the present disclosure, when the mobile device is located in a dark or textureless scene, the distance measurement module may be used to perform motion estimation on motion of the mobile device in the vertical direction. The use of the distance measurement module is independent from the brightness and texture of an environment. Therefore, the accuracy of motion estimation on the mobile device in a dark or textureless scene can be improved.

With reference to FIG. 2, the following provides an example of a detection mode in a dark scene. FIG. 2 includes step S210 to step S240. The following describes each step in FIG. 2 in detail.

Step S210: Obtain a picture of a current scene in which the mobile device is located with a camera on a mobile device=.

In a dark scene (such as at night or in a mine), the imaging quality of a picture may be very low. Therefore, in some exemplary embodiments, an exposure module and/or a fill light of the camera may be firstly used to increase the light intensity of an ambient environment, and then a picture of the current scene may be shot, so as to improve the imaging quality of the picture.

For example, when the mobile device detects that picture brightness is insufficient, the mobile device may use an automatic exposure control (AEC) algorithm to automatically increase an exposure time and an exposure gain, so that the camera can obtain a relatively bright picture without an additional device.

Increasing an exposure time may cause a motion blur in a picture, and increasing an exposure gain may increase image noise. If a motion blur or noise of an image is excessive, the accuracy of motion estimation on the mobile device may be reduced. Therefore, generally the exposure time and the exposure gain of the camera both have upper limits (that is, maximum values are preset for the exposure time and the exposure gain of the camera respectively). In use, the exposure time and/or the exposure gain of the camera may be adjusted up to a preset maximum value, and then a picture of the current scene is shot. Therefore, the light intensity of the ambient environment is increased as much as possible while ensuring that the motion blur or noise of the image is acceptable.

In addition, some mobile devices may be configured with a fill light, and the fill light may illuminate an ambient environment to improve the quality of a picture shot in a dark scene. Therefore, in some exemplary embodiments, the quality of the picture shot by the camera can also be improved by turning on the fill light.

It should be understood that, to increase light intensity of ambient light, the exposure module and the fill light of the camera may be used simultaneously, or only one of the exposure module and the fill light may be used. This is not limited in the present disclosure. For example, the exposure time and the exposure gain of the camera may be adjusted to preset maximum values first. After the exposure time and the exposure gain of the camera are adjusted to the preset maximum values, if the picture of the current scene still does not reach expected brightness, the fill light may be turned on.

Step S220: Detect brightness of the picture.

Herein the brightness may be either total brightness of the picture or average brightness of the picture. In a solution using the exposure module or the fill light, the brightness of the picture may be detected after the exposure module or the fill light works stably (for example, after both the exposure time and the exposure gain reach their maximum values, or the fill light has been fully turned on).

Step S230: When the brightness of the picture is greater than or equal to a preset first threshold, determine that the scene is a bright scene.

Step S240: When the brightness of the picture is less than a first threshold, determine that the scene is a dark scene.

A specific value of the preset first threshold may be selected based on experience or an experiment, and is not limited in the present disclosure.

With reference to FIG. 3, the following provides an example of a determining mode in a textureless scene. FIG. 3 includes step S310 to step S330. The following describes each step in FIG. 3 in detail.

Step S310: Obtain a picture of a current scene in which the mobile device is located with a camera on a mobile device.

Step S320: Obtain a contour map of an object in the scene by performing edge detection on the picture.

For example, a Sobel operator or Canny operator may be used to perform edge detection on the picture.

Step S330: When a quantity of characteristic points in the contour map is greater than or equal to a preset second threshold, determine that the scene is a textured scene.

A specific value of the second threshold may be selected based on experience or an experiment, and is not limited in the present disclosure.

Many modes may be used to extract or detect a characteristic point in the contour map. For example, a corner detection algorithm may be used to extract or detect a characteristic point. The corner detection algorithm may be, for example, a Harris & Stephens corner detection algorithm, a Plessey corner detection algorithm, or a Shi-Tomasi corner detection algorithm.

With reference to FIG. 4, the following describes exemplary implementations of step S130 in FIG. 1 in detail.

Step S410 (step S410 may occur before step S130): Obtain information about a rotational relationship between a device coordinate system and a world coordinate system of the mobile device with an inertial measurement unit in the mobile device.

Specifically, the inertial measurement unit may include an accelerometer and a gyroscope. The inertial measurement unit may perform motion estimation on the mobile device from the previous moment to the current moment according to the following formulas:

$$\dot{p} = v ;$$

$$\dot{v} = {R}_{wi} ( {a}_{m} - {b}_{a} ) + g ;$$

$$\dot{q} = \frac{1}{2} q ⊗ [ \begin{matrix}0 \\ ( ω - {b}_{ω} )\end{matrix} ] ;$$

$$\dot{{b}_{a}} = 0 ; and$$

$$\dot{{b}_{ω}} = 0.$$

The foregoing formulas are converted from a continuous form to a discrete form, and the following formulas may be obtained:

$${p}_{k + 1} = {p}_{k} + {v}_{k} Δ t + \frac{1}{2} ( {R}_{w i} ( {a}_{m} - {b}_{a} ) + g ) Δ {t}^{2} ;$$

$${v}_{k + 1} = {v}_{k} + ( {R}_{w i} ( {a}_{m} - {b}_{a} ) + g ) Δ t ;$$

$${q}_{k + 1} = {q}_{k} ⊗ Δ q ;$$

$$Δ q = q \{ ( ω - {b}_{ω} ) Δ t \} ;$$

$${( {b}_{a} )}_{k + 1} = {( {b}_{a} )}_{k} ; {and \\ ( {b}_{ω} )}_{k + 1} = {( {b}_{ω} )}_{k} ;$$

where pₖ₊₁ represents a location of the mobile device at the current moment, vₖ₊₁ represents a speed of the mobile device at the current moment, qₖ₊₁ represents a posture 4-tuple of the mobile device at the current moment, (bₐ)ₖ₊₁_{ₖ₊₁} represents a zero-axis deviation of the accelerometer in the inertial measurement unit at the current moment, and (b_{ω})ₖ₊₁ represents a zero-axis deviation of the gyroscope in the inertial measurement unit at the current moment;

pₖ represents a location of the mobile device at the previous moment, vₖ represents a speed of the mobile device at the previous moment, qₖ represents a posture 4-tuple of the mobile device at the previous moment, (bₐ)ₖ represents a zero-axis deviation of the accelerometer in the inertial measurement unit at the previous moment, and (b_{ω})ₖ represents a zero-axis deviation of the gyroscope in the inertial measurement unit at the previous moment.

Δt represents a time difference between the previous moment and the current moment. Assuming that an image sampling frequency is 20 Hz, Δt is approximately equal to 50 ms. R_{wi}; represents the rotational relationship between the device coordinate system of the mobile device and the world coordinate system, where the rotational relationship may be obtained by converting the posture 4-tuple q. aₘ represents a reading of the accelerometer at the current moment. g represents gravity acceleration. ω represents a reading of the gyroscope at the current moment. Δq represents a posture difference of the mobile device between the current moment and the previous moment, and if ∥ω−b_{ω}∥₂<ωₜₕ, it indicates that a posture of the mobile device is stable.

As can be seen from the foregoing formulas, R_{wi} is the information about the rotational relationship between the device coordinate system and the world coordinate system of the mobile device at the current moment, and the information about the rotational relationship may be calculated by obtaining R_{wi}

Still referring to FIG. 4, after the information about the rotational relationship between the device coordinate system and the world coordinate system of the mobile device is obtained, step S130 may be further divided into step S420 and step S430.

Step S420: Convert a three-dimensional point cloud in the first depth map from the device coordinate system to the world coordinate system based on the information about the rotational relationship, to obtain a second depth map.

The three-dimensional point cloud in the first depth map is a three-dimensional point cloud in the device coordinate system. Based on the information about the rotational relationship output in step S410, each point in the first depth map is converted from the device coordinate system to the world coordinate system according to the following formula:

P^{W}=R_{D}^{W}P^{D};

where P^{D} represents a coordinate of the three-dimensional point cloud in the device coordinate system, P^{W} represents a coordinate of the three-dimensional point cloud in the world coordinate system, and R_{D}^{W} represents the information about the rotational relationship between the device coordinate system and the world coordinate system of the mobile device, which is equivalent to the foregoing R_{wi}.

Step S430: Determine the vertical distance between the mobile device and the ground at the current moment based on the second depth map.

The three-dimensional point cloud is converted from the device coordinate system to the world coordinate system, so that the vertical distance between the mobile device and ground can be calculated more simply and intuitively.

There may be a plurality of ways to implement step S430. For example, plane fitting may be performed on a three-dimensional point cloud below the mobile device in the second depth map, a plane obtained by fitting is then used as the ground, and a vertical distance between the mobile device and the ground is calculated. For another example, a first point that the mobile device may encounter when the mobile device moves in the vertical direction may be calculated, and then a distance between this point and the mobile device is used as the vertical distance between the mobile device and the ground at the current moment.

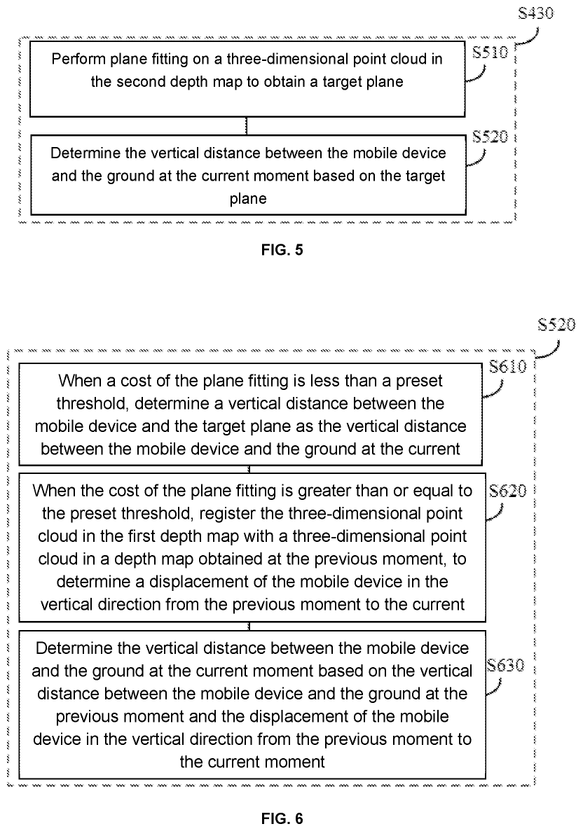

With reference to FIG. 5, the following is detailed exemplary description of a mode of determining the vertical distance between the mobile device and the ground at the current moment based on plane fitting.

As shown in FIG. 5, step S430 may include S510 and step S520.

Step S510: Perform plane fitting on a three-dimensional point cloud (such as a three-dimensional point cloud below the mobile device in the world coordinate system) in the second depth map to obtain a target plane.

There may be a plurality of ways of plane fitting. For example, plane fitting may be performed on the three-dimensional point cloud in the second depth map by using a least square algorithm, or plane fitting may be performed on the three-dimensional point cloud in the second depth map by using a Levenberg-Marquardt algorithm.

Step S520: Determine the vertical distance between the mobile device and the ground at the current moment based on the target plane.

There may be a plurality of ways to implement step S520. In some exemplary embodiments, a vertical distance between the mobile device and the target plane may be directly determined as the vertical distance between the mobile device and the ground at the current moment.

In some exemplary embodiments, an appropriate way of determining the distance may be selected from a plurality of preset distance determining modes based on their costs of the plane fitting of the target plane. The following describes this implementation in detail with reference to FIG. 6.

As shown in FIG. 6, step S520 may include S610 to step S630.

Step S610: When a cost of the plane fitting is less than a preset threshold, determine a vertical distance between the mobile device and the target plane as the vertical distance between the mobile device and the ground at the current moment.

The cost of the plane fitting may be used to indicate the smoothness of the ground. A high cost of the plane fitting may indicate that the ground is rough. A low cost of the plane fitting may indicate that the ground is smooth.

Assuming that the Levenberg-Marquardt algorithm is used to perform plane fitting, a target equation of the algorithm is as follows:

S(β)=Σᵢ₌₁ⁿ[Yᵢ−f(P_{w,i},β)]².

$$f ( {P}_{w , i} , β ) = \frac{\vert a x + b y + c z + d \vert}{\sqrt{{a}^{2} + {b}^{2} + {c}^{2}}} + ɛ \vert {a}^{2} + {b}^{2} + {c}^{2} + {d}^{2} + 1 \vert .$$

A residual vector r satisfies the following equation:

$$r = {Y}_{i} - f ( {P}_{w , i} , β ) = - \frac{\vert a x + b y + c z + d \vert}{\sqrt{{a}^{2} + {b}^{2} + {c}^{2}}} - ɛ \vert {a}^{2} + {b}^{2} + {c}^{2} + {d}^{2} + 1 \vert .$$

A cost equation C may be expressed by using the following equation:

min C=Σᵢ₌₁ⁿr².

The target equation is solved in an iterative mode, and a finally calculated plane equation is used as a target plane equation to determine the target plane. Then the cost (a value of C indicates the cost of the plane fitting) of the plane fitting of the target plane may be obtained based on a cost equation corresponding to the target equation. If the cost of the plane fitting is low, it may be considered that the target plane is smooth, and the following mode may be used to directly calculate a distance D from the mobile device to the target plane:

$$D = \frac{\vert d \vert}{\sqrt{{a}^{2} + {b}^{2} + {c}^{2}}} .$$

A plane normal vector may be obtained based on the plane equation:

[symbol]

=(a,b,c).

A unit vector in the vertical direction is:

[symbol]

=(0,0,1).

Therefore, an angle θ between the target plane and the vertical direction satisfies the following relationship:

$$cos θ = \frac{\vec{n} \cdot \vec{m}}{\vert \vec{n} \vert \cdot \vert \vec{m} \vert} .$$

Therefore, a vertical distance h between the mobile device and the target plane satisfies:

$$h = D \cdot cos θ = \frac{\vert d \vert}{\sqrt{{a}^{2} + {b}^{2} + {c}^{2}}} \cdot \frac{\vec{n} \cdot \vec{m}}{\vert \vec{n} \vert \cdot \vert \vec{m} \vert} .$$

If the cost of the plane fitting is excessively high, it indicates that the target plane is very rough, and the vertical distance between the mobile device and ground at the current moment may be calculated in the mode described in step S620 and step S630.

Step S620: When the cost of the plane fitting is greater than or equal to the preset threshold, register the three-dimensional point cloud in the first depth map with a three-dimensional point cloud in a depth map obtained at the previous moment, to determine a displacement of the mobile device in the vertical direction from the previous moment to the current moment.

For example, an iterative closest point (ICP) algorithm may be used to register the three-dimensional point cloud in the first depth map with the three-dimensional point cloud in the depth map obtained at the previous moment. Position-posture change information of the mobile device may be obtained by using the ICP algorithm. Then the displacement of the mobile device in the vertical direction from the previous moment to the current moment may be obtained from the position-posture change information, and further, the moving speed of the mobile device from the previous moment to the current moment in the vertical direction is calculated.

Step S630: Determine the vertical distance between the mobile device and the ground at the current moment based on the vertical distance between the mobile device and the ground at the previous moment and the displacement of the mobile device in the vertical direction from the previous moment to the current moment.

In this exemplary embodiment of the present disclosure, when the cost of the plane fitting is high, a three-dimensional point cloud registration mode may be used to determine the vertical distance between the mobile device and the ground at the current moment; or when the cost of the plane fitting is low, a distance relationship between a point and a plane is used to determine the vertical distance between the mobile device and the ground at the current moment. Therefore, a calculation policy of the mobile device becomes more flexible, and a calculation result is more accurate.

A motion estimation mode for the mobile device located in a dark or a textureless scene has been described above with reference to FIG. 1 to FIG. 6. When the mobile device is located in a bright and textured scene, the distance measurement module may still be used to perform motion estimation, or a visual+inertial navigation system may be used based on a conventional mode, and motion estimation is performed by using a VO or VIO algorithm.

In addition, no matter which mode described above is used to perform motion estimation, after an estimation result is obtained, a Kalman filter may be used to filter the estimation result, so that the estimation result is more accurate.

Further, the present disclosure further provides a motion compensation method. The method may include steps of motion estimation described in any one of the foregoing exemplary embodiments, and may further include a step of canceling motion of the mobile device in the vertical direction. The mobile device may be, for example, a handheld photographing device, such as a handheld gimbal. For example, when a user holds a photographing device to perform photographing, motion in the vertical direction is generally caused by a hand tremble. When motion in the vertical direction is detected, the photographing device may be controlled to move at a same speed in an opposite direction to cancel the motion of the photographing device in the vertical direction, thereby improving the quality of a shot image.

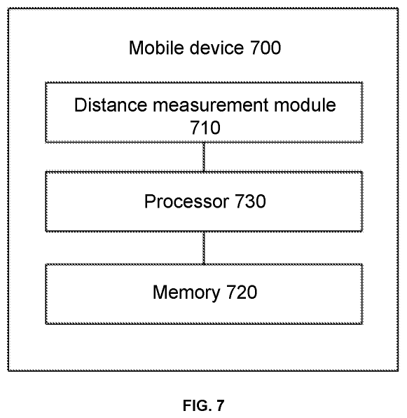

Some exemplary embodiments of the present disclosure further provide a mobile device. As shown in FIG. 7, the mobile device 700 may include a distance measurement module 710, at least one memory 720, and at least one processor 730. The at least one memory (or storage device) 720 may be configured to store an instruction. The at least one processor 730 is in communication with the at least one memory, and is configured to execute the instruction to perform the following operations: detecting whether a scene in which the mobile device 700 is currently located is a dark scene or a textureless scene; when the scene is a dark scene or a textureless scene, obtaining a first depth map of the scene with the distance measurement module; determining a vertical distance between the mobile device 700 and the ground at a current moment based on the first depth map; and determining a moving speed of the mobile device 700 from a previous moment to the current moment in a vertical direction based on a vertical distance between the mobile device 700 and the ground at the previous moment and the vertical distance between the mobile device 700 and the ground at the current moment.

In some examples, the processor 730 may be further configured to perform the following operation: obtaining information about a rotational relationship between a device coordinate system and a world coordinate system of the mobile device 700 with an inertial measurement unit in the mobile device 700; and the determining a vertical distance between the mobile device 700 and the ground at a current moment based on the first depth map includes: converting a three-dimensional point cloud in the first depth map from the device coordinate system to the world coordinate system based on the information about the rotational relationship to obtain a second depth map; and determining the vertical distance between the mobile device 700 and the ground at the current moment based on the second depth map.

In some examples, the determining the vertical distance between the mobile device 700 and ground at the current moment based on the second depth map includes: obtain a target plane by performing plane fitting on a three-dimensional point cloud in the second depth map; and determining the vertical distance between the mobile device 700 and the ground at the current moment based on the target plane.

In some examples, the determining the vertical distance between the mobile device 700 and ground at the current moment based on the target plane includes: when a cost of the plane fitting is less than a preset threshold, determining a vertical distance between the mobile device 700 and the target plane as the vertical distance between the mobile device 700 and the ground at the current moment.

In some examples, the determining the vertical distance between the mobile device 700 and the ground at the current moment based on the target plane further includes: when the cost of the plane fitting is greater than or equal to the preset threshold, registering the three-dimensional point cloud in the first depth map with a three-dimensional point cloud in a depth map obtained at the previous moment, to determine a displacement of the mobile device 700 in the vertical direction from the previous moment to the current moment; and determining the vertical distance between the mobile device 700 and the ground at the current moment based on the vertical distance between the mobile device 700 and the ground at the previous moment and the displacement of the mobile device 700 in the vertical direction from the previous moment to the current moment.

In some examples, the registering the three-dimensional point cloud in the first depth map with a three-dimensional point cloud in a depth map obtained at the previous moment includes: registering, by using an iterative closest point algorithm, the three-dimensional point cloud in the first depth map with the three-dimensional point cloud in the depth map obtained at the previous moment.

In some examples, the performing plane fitting on a three-dimensional point cloud in the second depth map includes: performing plane fitting on the three-dimensional point cloud in the second depth map by using a Levenberg-Marquardt algorithm.

In some examples, the processor 730 is further configured to perform the following operation: when the scene is a bright and textured scene, performing motion estimation on motion of the mobile device 700 in the vertical direction with a camera and the inertial measurement unit in the mobile device 700.

In some examples, the detecting whether a scene in which the mobile device 700 is currently located is a dark scene or a textureless scene includes: obtaining a picture of the scene with the camera; and detecting, based on brightness and/or a texture of the picture, whether the scene is a dark scene or a textureless scene.

In some examples, the detecting, based on brightness and/or a texture of the picture, whether the scene is a dark scene or a textureless scene includes: detecting the brightness of the picture; and when the brightness of the picture is greater than or equal to a preset first threshold, determining that the scene is a bright scene; or when the brightness of the picture is less than a first threshold, determining that the scene is a dark scene.

In some examples, the detecting, based on brightness and/or a texture of the picture, whether the scene is a dark scene or a textureless scene includes: performing edge detection on the picture, to obtain a contour map of an object in the scene; and when a quantity of characteristic points in the contour map is greater than or equal to a preset second threshold, determining that the scene is a textured scene; or when a quantity of characteristic points in the contour map is less than a second threshold, determining that the scene is a textureless scene.

In some examples, before the obtaining a picture of the scene with the camera, the processor 730 is further configured to perform the following operations: adjusting an exposure time and/or an exposure gain of the camera to a preset maximum value; and/or turning on a fill light in the mobile device 700.

In some examples, the distance measurement module 710 is a three-dimensional depth sensor based on structured light.

In some examples, the structured light is infrared light.

In some examples, the mobile device 700 is a handheld photographing device, an unmanned aerial vehicle, an unmanned vehicle, virtual reality glasses, augmented reality glasses, or a mobile phone.

All or some of the foregoing exemplary embodiments may be implemented by software, hardware, firmware, or any combination thereof. When software is used to implement the embodiments, the embodiments may be implemented in a form of a computer program product. The computer program product includes one or more computer instructions. When the computer program instructions are loaded and executed on a computer, the procedure or functions according to the embodiments of the present disclosure are fully or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or may be a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

It should be noted that, provided that there is no conflict, each embodiment described in the present disclosure and/or the technical feature in each embodiment may be combined in any way, and a technical solution obtained after the combination shall also fall within the scope of protection of the present disclosure.

A person of ordinary skill in the art may appreciate that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, which should not be considered as going beyond the scope of the present disclosure.

In exemplary embodiments provided in the present disclosure, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or may not be performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network elements. Some or all of the units may be selected based on actual requirements to achieve the objects of the solutions of the embodiments.

In addition, functional units in the embodiments of the present disclosure may be integrated into one processing unit, or each of the units may exist alone physically, or two or more units may be integrated into one unit.

The foregoing descriptions are merely specific implementations of the present disclosure, but are not intended to limit the protection scope of the present disclosure. Any variation or replacement readily conceivable by a person skilled in the art within the technical scope disclosed in the present disclosure shall fall within the scope of protection of the present disclosure. Therefore, the scope of protection of the present disclosure shall be subject to the appended claims.

What is claimed is:

1. A motion estimation method for a mobile device, comprising:
detecting whether a scene in which the mobile device is currently located is a dark scene or a textureless scene;
after detecting that the scene is a dark scene or a textureless scene, obtaining a first depth map of the scene with a distance measurement module in the mobile device;
determining a vertical distance between the mobile device and ground at a current moment based on the first depth map; and
determining a moving speed of the mobile device from a previous moment to the current moment in a vertical direction based on a vertical distance between the mobile device and the ground at the previous moment and the vertical distance between the mobile device and ground at the current moment.

2. The method according to claim 1, further comprising:
obtaining a rotational relationship between a device coordinate system and a world coordinate system of the mobile device with an inertial measurement unit in the mobile device; and
wherein the determining of the vertical distance between the mobile device and the ground at the current moment based on the first depth map includes:
converting a three-dimensional point cloud in the first depth map from the device coordinate system to the world coordinate system based on the rotational relationship to obtain a second depth map; and
determining the vertical distance between the mobile device and the ground at the current moment based on the second depth map.

3. The method according to claim 2, wherein the determining of the vertical distance between the mobile device and the ground at the current moment based on the second depth map includes:
performing plane fitting on a three-dimensional point cloud in the second depth map to obtain a target plane; and
determining the vertical distance between the mobile device and the ground at the current moment based on the target plane.

4. The method according to claim 3, wherein the determining of the vertical distance between the mobile device and the ground at the current moment based on the target plane includes:
after determining that a cost of the plane fitting is less than a preset threshold, determining a vertical distance between the mobile device and the target plane as the vertical distance between the mobile device and the ground at the current moment.

5. The method according to claim 4, wherein the determining of the vertical distance between the mobile device and the ground at the current moment based on the target plane further includes:
after determining that the cost of the plane fitting is greater than or equal to the preset threshold, registering the three-dimensional point cloud in the first depth map with a three-dimensional point cloud in a depth map obtained at the previous moment, so as to determine a displacement of the mobile device in the vertical direction from the previous moment to the current moment; and
determining the vertical distance between the mobile device and the ground at the current moment based on the vertical distance between the mobile device and the ground at the previous moment and the displacement of the mobile device in the vertical direction from the previous moment to the current moment.

6. The method according to claim 5, wherein the registering of the three-dimensional point cloud in the first depth map with a three-dimensional point cloud in a depth map obtained at the previous moment includes:
registering, by using an iterative closest point algorithm, the three-dimensional point cloud in the first depth map with the three-dimensional point cloud in the depth map obtained at the previous moment.

7. The method according to claim 3, wherein the performing of the plane fitting on a three-dimensional point cloud in the second depth map includes:
performing the plane fitting on the three-dimensional point cloud in the second depth map with a Levenberg-Marquardt algorithm.

8. The method according to claim 1, further comprising:
after determining that the scene is a bright and textured scene, performing motion estimation on motion of the mobile device in the vertical direction with a camera and an inertial measurement unit in the mobile device.

9. The method according to claim 1, wherein the detecting of whether a scene in which the mobile device is currently located is a dark scene or a textureless scene includes:
obtaining a picture of the scene with a camera; and
detecting, based on at least one of a brightness or a texture of the picture, whether the scene is a dark scene or a textureless scene

10. The method according to claim 9, wherein the detecting, based on at least one of brightness or a texture of the picture, of whether the scene is a dark scene or a textureless scene includes:
detecting the brightness of the picture; and
after detecting that the brightness of the picture is greater than or equal to a preset first threshold, determining that the scene is a bright scene; or
after detecting that the brightness of the picture is less than the first threshold, determining that the scene is a dark scene.

11. The method according to claim 9, wherein the detecting, based on at least one of brightness or a texture of the picture, of whether the scene is a dark scene or a textureless scene includes:
performing edge detection on the picture to obtain a contour map of an object in the scene; and
after determining that a quantity of characteristic points in the contour map is greater than or equal to a preset second threshold, determining that the scene is a textured scene; or
after determining that a quantity of characteristic points in the contour map is less than the second threshold, determining that the scene is a textureless scene.

12. The method according to claim 9, further comprising, before obtaining the picture of the scene with the camera:
adjusting at least one of an exposure time or an exposure gain of the camera to a preset maximum value of the exposure time or the exposure gain; or
turning on a fill light in the mobile device.

13. A mobile device, comprising:
a distance measurement module;
at least one memory storing a set of instructions; and
at least one processor in communication with the at least one memory, wherein during operation, the at least one processor executes the set of instructions to:
detect whether a scene in which the mobile device is currently located is a dark scene or a textureless scene;
after detecting that the scene is a dark scene or a textureless scene, obtain a first depth map of the scene with the distance measurement module;
determine a vertical distance between the mobile device and ground at a current moment based on the first depth map; and
determine a moving speed of the mobile device from a previous moment to the current moment in a vertical direction based on a vertical distance between the mobile device and the ground at the previous moment and the vertical distance between the mobile device and ground at the current moment.

14. The mobile device according to claim 13, wherein the at least one processor further:
obtains a rotational relationship between a device coordinate system and a world coordinate system of the mobile device with an inertial measurement unit in the mobile device; and
to determine the vertical distance between the mobile device and the ground at the current moment based on the first depth map, the at least one processor further:
converts a three-dimensional point cloud in the first depth map from the device coordinate system to the world coordinate system based on the rotational relationship to obtain a second depth map; and
determines the vertical distance between the mobile device and the ground at the current moment based on the second depth map.

15. The mobile device according to claim 14, wherein to determine the vertical distance between the mobile device and the ground at the current moment based on the second depth map, the at least one processor further:
performs plane fitting on a three-dimensional point cloud in the second depth map, to obtain a target plane; and
determines the vertical distance between the mobile device and ground at the current moment based on the target plane.

16. The mobile device according to claim 15, wherein to determine the vertical distance between the mobile device and the ground at the current moment based on the target plane, the at least one processor further:
after determining that a cost of the plane fitting is less than a preset threshold, determines a vertical distance between the mobile device and the target plane as the vertical distance between the mobile device and the ground at the current moment.

17. The mobile device according to claim 16, wherein to determine the vertical distance between the mobile device and the ground at the current moment based on the target plane, the at least one processor further:
after determining that the cost of the plane fitting is greater than or equal to the preset threshold, registers the three-dimensional point cloud in the first depth map with a three-dimensional point cloud in a depth map obtained at the previous moment, so as to determine a displacement of the mobile device in the vertical direction from the previous moment to the current moment; and
determines the vertical distance between the mobile device and the ground at the current moment based on the vertical distance between the mobile device and the ground at the previous moment and the displacement of the mobile device in the vertical direction from the previous moment to the current moment.

18. The mobile device according to claim 17, wherein to register the three-dimensional point cloud in the first depth map with the three-dimensional point cloud in the depth map obtained at the previous moment, the at least one processor further:
registers, by using an iterative closest point algorithm, the three-dimensional point cloud in the first depth map with the three-dimensional point cloud in the depth map obtained at the previous moment.

19. The mobile device according to claim 15, wherein to perform the plane fitting on the three-dimensional point cloud in the second depth map, the at least one processor further:
performs the plane fitting on the three-dimensional point cloud in the second depth map with a Levenberg-Marquardt algorithm.

20. The mobile device according to claim 13, wherein the at least one processor further:
after determining that the scene is a bright and textured scene, performs motion estimation on motion of the mobile device in the vertical direction by using a camera and an inertial measurement unit in the mobile device.

21. The mobile device according to claim 13, wherein to detect whether the scene in which the mobile device is currently located is a dark scene or a textureless scene, the at least one processor further:
obtains a picture of the scene with the camera; and
detects, based on at least one of a brightness or a texture of the picture, whether the scene is a dark scene or a textureless scene.

22. The mobile device according to claim 21, wherein to detect, based on at least one of the brightness or the texture of the picture, whether the scene is a dark scene or a textureless scene, the at least one processor further:
detects the brightness of the picture; and
after detecting that the brightness of the picture is greater or equal to than a preset first threshold, determines that the scene is a bright scene; or
after detecting that the brightness of the picture is less than the first threshold, determines that the scene is a dark scene.

23. The mobile device according to claim 21, wherein to detect, based on at least one of the brightness or the texture of the picture, whether the scene is a dark scene or a textureless scene, the at least one processor further:
performs edge detection on the picture, to obtain a contour map of an object in the scene; and
after determining that a quantity of characteristic points in the contour map is greater than or equal to a preset second threshold, determines that the scene is a textured scene; or
after determining that a quantity of characteristic points in the contour map is less than the second threshold, determines that the scene is a textureless scene.

24. The mobile device according to claim 21, wherein before obtaining the picture of the scene with the camera, the processor further:
adjusts at least one of an exposure time or an exposure gain of the camera to a preset maximum value of the exposure time or the exposure gain; or
turns on a fill light in the mobile device.
